(19) United States
(12) Patent Application Publication
(10) Pub. No.: US 2022/0414983 A1
(43) Pub. Date: Dec. 29, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventors: GAKU NARITA, TOKYO (JP); TOMOYA ISHIKAWA, Tokyo (JP); TAKASHI SENO, Tokyo (JP); TOMU TAHARA, Tokyo (JP)

(21) Appl. No.: 17/755,929

(22) PCT Filed: Oct. 29, 2020
(86) PCT No.: PCT/JP2020/040608

§ 371 Date: May 11, 2022

(30) Foreign Application Priority Data
Nov. 19, 2019 (JP) 2019-208696

(51) Int. Cl. G06T 17/05; G06V 20/50

(52) U.S. Cl. CPC G06T 17/05; G06V 20/50

(57) ABSTRACT

An object detection unit 31 detects, for example, a moving object and a detection target object that coincides with a registered object registered in an object database from an input image. A map processing unit 32 updates information of an area corresponding to the detected object in a 3D map including a signed distance, a weight parameter, and an object ID label according to an object detection result by the object detection unit 31. For example, when the moving object is detected, the map processing unit 32 initializes information of an area corresponding to the moving object in the 3D map. The map processing unit 32 registers an object map of the detected moving object in the object database. When the detection target object is detected, the map processing unit 32 converts an object map of the registered object that coincides with the detection target object according to a posture of the detection target object and integrates the same with the 3D map. Movement of the object may be quickly reflected on the map.

### TECHNICAL FIELD

The present technology relates to an information processing device, an information processing method, and a program, and this makes it possible to quickly reflect a moving object on a map.

### BACKGROUND ART

Conventionally, in AR, VR, robotics or the like, an environment around a user or a robot is three-dimensionally reconstructed. Furthermore, in a three-dimensional reconstruction, a method of representing a scene by a point group, and a method of using an occupancy grid that probabilistically represents presence or absence of an object surface are used. Furthermore, Non-Patent Document 1 discloses a method of using a signed distance field to an object surface, and the method of using the signed distance field has advantages that, for example, it is possible to detect a free space (a space in which no object is present) important in an operation plan, to extract a polygon mesh important in drawing occlusion or in physical simulation and the like, and is most common and widely used.

### CITATION LIST

### Non-Patent Document

Non-Patent Document 1: Newcombe, Richard A, et al. “Kinectfusion: Real-time dense surface mapping and tracking.” ISMAR. Vol. 11, No. 2011.

### SUMMARY OF THE INVENTION

### Problems to be Solved by the Invention

By the way, in a method of using a signed distance field, a depth image at certain time and a posture of a sensor that generates the depth image are acquired, and a point group (hereinafter, “scan point group”) obtained by back projecting the depth image is converted into a three-dimensional map coordinate system on the basis of the sensor posture. Note that, the three-dimensional map (also referred to as “3D map”) is a set of elements referred to as voxels obtained by dividing a three-dimensional space into a grid shape, and each voxel stores a signed distance to an object surface (positive outside an object, and negative inside the object, with an object surface as 0), and a weight parameter for indicating reliability of the signed distance. Next, the signed distance to the object surface and the weight parameter stored in each voxel of the 3D map are sequentially updated in a manner of moving average on the basis of a distance from the sensor center to each point of the scan point group.

In this manner, since the signed distance and the weight parameter are sequentially updated as expressed by Expressions (1) and (2), a latency until a change in position of the object is reflected on the 3D map is high. Note that, in Expressions (1) and (2), a coded distance and a weight parameter stored in a voxel v are “D(v)” and “W(v)”, respectively, and a coded distance and a weight parameter of the scan point group are “d(v)” and “w(v)”, respectively.

$$\begin{matrix}[ Math . 1 ] & \\ D ( v ) ← \frac{W ( v ) D ( v ) + w ( v ) d ( v )}{W ( v ) + w ( v )} & ( 1 )\end{matrix}$$

$$W ( v ) ← W ( v ) + w ( v ) \qquad ( 2 )$$

Therefore, for example, when a stationary object moves at certain time, a latency of a certain period of time or more occurs until the movement of the object is reflected on the 3D map, and it takes time until a polygon mesh indicating the stationary object is deleted. Furthermore, when an object newly appears in a free space in an environment, a latency of a certain time or more occurs until the appearing object is reflected on the 3D map, and it takes time to generate a polygon mesh indicating the appearing object.

Therefore, it is an object of this technology to provide an information processing device, an information processing method, and a program capable of quickly reflecting movement of an object on a map.

### Solutions to Problems

A first aspect of the present technology is an information processing device including:

an object detection unit that detects an object from an input image; and

a map processing unit that updates information of an area corresponding to the detected object in an environment map according to a detection result of the object by the object detection unit.

In this technology, the object detection unit detects, for example, a moving object, a non-moving object, and a detection target object that coincides with a registered object registered in an object database from the input image. The map processing unit updates information of an area corresponding to the detected object in the environment map, for example, a three-dimensional map including a signed distance, a weight parameter, and object specific information according to the detection result of the object by the object detection unit. For example, when the moving object is detected by the object detection unit, the map processing unit initializes information of an area corresponding to the moving object in the environment map. Furthermore, the map processing unit registers an object map of the moving object and the non-moving object detected by the object detection unit in the object database. Moreover, the map processing unit converts, in a case of detecting the detection target object by the object detection unit, the object map of the registered object that coincides with the detection target object into a map according to a posture of the detection target object, and integrates the converted object map with the environment map. Note that, the map processing unit may delete the registered object that coincides with the detection target object from the object database.

Furthermore, a polygon mesh extraction unit that extracts a polygon mesh from the three-dimensional map updated by the map processing unit is further provided, and the polygon mesh extraction unit extracts a polygon mesh for each object on the basis of the object specific information.

A second aspect of the technology is an information processing method including:

detecting an object from an input image by an object detection unit; and

updating information of an area corresponding to the detected object in an environment map by a map processing unit according to a detection result of the object by the object detection unit.

A third aspect of the technology is a program for causing a computer to execute processing of an environment map, the program for causing the computer to execute:

a procedure of detecting an object from an input image; and

a procedure of updating information of an area corresponding to the detected object in the environment map according to a detection result of the object by the object detection unit.

Note that, the program of the present technology is the program that may be provided by a storage medium and a communication medium provided in a computer-readable form, for example, a storage medium such as an optical disk, a magnetic disk, and a semiconductor memory, or a communication medium such as a network to a general-purpose computer capable of executing various program codes, for example. By providing such program in the computer-readable form, processing according to the program is implemented on the computer.

### BRIEF DESCRIPTION OF DRAWINGS

FIG. 1 is a view illustrating a configuration of a system using an information processing device.

FIG. 2 is a view illustrating a functional configuration of an information processing unit.

FIG. 3 is a view illustrating a voxel.

FIG. 4 is a view illustrating a signed distance.

FIG. 5 is a view illustrating information of one voxel forming a 3D map.

FIG. 6 is a view illustrating an object database.

FIG. 7 is a flowchart illustrating an operation of a first embodiment.

FIG. 8 is a flowchart illustrating moving object detection processing.

FIG. 9 is a flowchart illustrating registered object detection processing.

FIG. 10 is a flowchart illustrating an operation of another embodiment.

FIG. 11 is a flowchart illustrating an operation of another embodiment.

### MODE FOR CARRYING OUT THE INVENTION

Hereinafter, a mode for carrying out the present technology is described. Note that, the description is given in the following order.

1. Configuration of System

2. Operation of First Embodiment of Information Processing Unit

3. Operation of Another Embodiment of Information Processing Unit

4. Application Example

<1. Configuration of System>

In an information processing device of the present technology, an object is detected from an input image, and information of an area corresponding to the detected object in an environment map is updated according to a detection result of the object. Hereinafter, a case where a three-dimensional map (also referred to as a “3D map”) is used as the environment map is described.

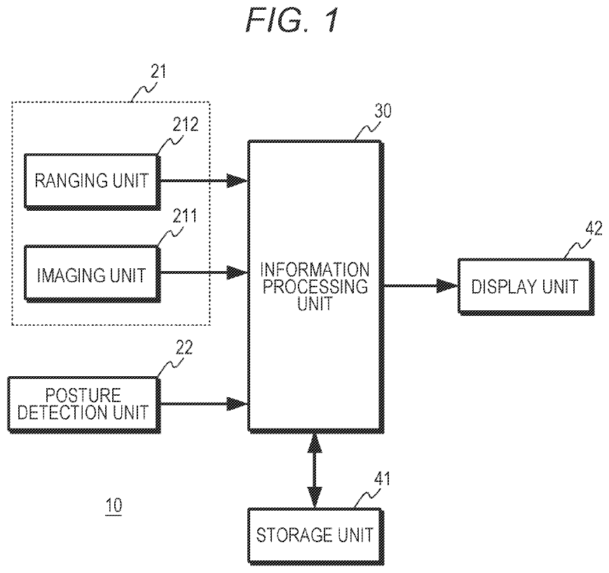

FIG. 1 illustrates a configuration of a system using the information processing device of the present technology. A system 10 includes a sensor unit 21, a posture detection unit 22, an information processing unit 30, a storage unit 41, and a display unit 42.

The sensor unit 21 acquires a captured image and a depth image as input images. The sensor unit 21 includes an imaging unit 211 and a ranging unit 212.

The imaging unit 211 is formed by using a complementary metal oxide semiconductor (CMOS) image sensor, a charge coupled device (CCD) image sensor and the like, for example. The imaging unit 211 performs photoelectric conversion, generates a captured image corresponding to a subject optical image, and outputs the same to the information processing unit 30.

The ranging unit 212 is formed by using, for example, a time of flight (ToF) type ranging sensor, a stereo camera, light detection and ranging (LiDAR) or the like. The ranging unit 212 generates a depth image indicating a distance to a subject captured by the imaging unit 211 and outputs the same to the information processing unit 30.

The posture detection unit 22 detects a posture of the sensor unit 21 used for acquiring the input image using any odometry and acquires posture information. For example, the posture detection unit 22 acquires the posture information (for example, six degrees of freedom (6Dof)) using an IMU sensor and the like and outputs the same to the information processing unit 30.

The information processing unit 30 generates and updates the environment map, for example, the 3D map, and generates, updates and the like an object database on the basis of the input image acquired by the sensor unit 21 and the posture information acquired by the posture detection unit 22. Furthermore, the information processing unit 30 updates the 3D map on the basis of a detection result of a moving object or a moving object registered in the object database, so that this may delete a moved moving object, extract a polygon mesh of a newly detected moving object and the like quickly in the polygon mesh extracted from the 3D map.

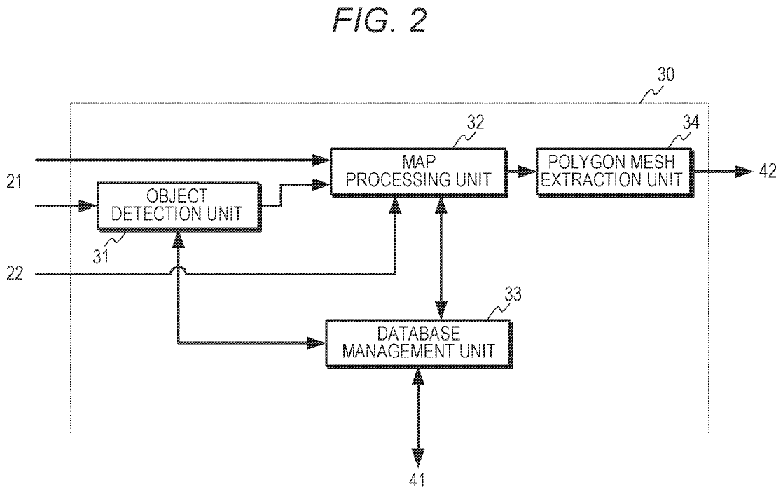

FIG. 2 illustrates a functional configuration of the information processing unit. The information processing unit 30 includes an object detection unit 31, a map processing unit 32, a database management unit 33, and a polygon mesh extraction unit 34.

The object detection unit 31 performs motion detection using, for example, the captured image acquired by the imaging unit 211, and detects a moving object included in the captured image. Note that, when detecting the moving object, the depth image generated by the ranging unit 212 may further be used. Furthermore, the object detection unit 31 detects a detection target object that coincides with a registered object registered in the object database to be described later. The object detection unit 31 outputs an object detection result to the map processing unit 32.

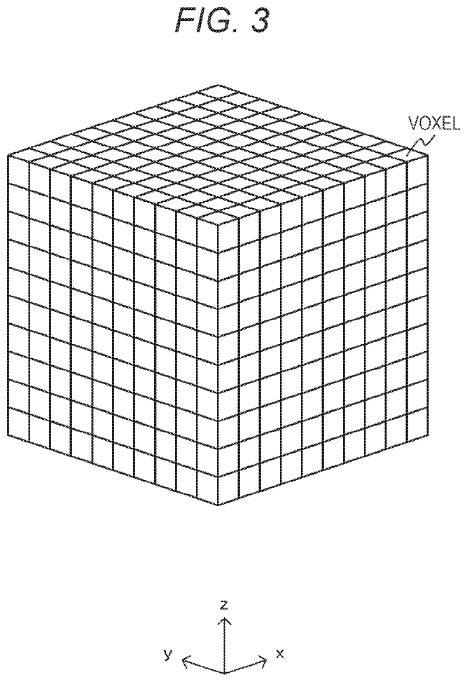

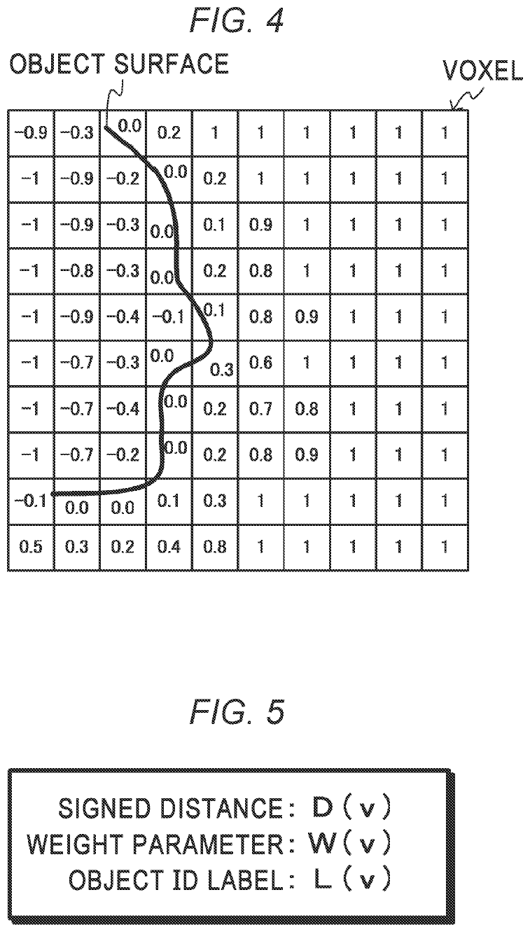

The map processing unit 32 generates the 3D map and integrates information with the 3D map. The map processing unit 32 generates the 3D map on the basis of the depth image generated by the ranging unit 212. As illustrated in FIG. 3, the 3D map is a set of elements referred to as voxels obtained by dividing a three-dimensional space into a grid shape. As disclosed in Non-Patent Document 1, each voxel may store a signed distance (positive distance outside an object and negative distance inside the object with an object surface as reference “0”) D(v), and a weight parameter W(v) for indicating reliability of the signed distance. Note that, FIG. 4 illustrates the signed distance. Moreover, in the present technology, the 3D map may store an object ID label L(v). The object ID label is object specific information indicating an object specific label.

The map processing unit 32 converts a point group (hereinafter referred to as a “scan point group”) acquired by back projecting for each pixel of the depth image into a 3D map coordinate system on the basis of the sensor posture on the basis of the depth image acquired by the sensor unit 21 and the posture information acquired by the posture detection unit 22. Moreover, the signed distance and the weight parameter of each voxel of the 3D map are set on the basis of a distance from the sensor center (ranging center of the ranging unit 212) to each point of the scan point group. Furthermore, the map processing unit 32 stores the object ID label L(v) in each voxel forming the 3D map on the basis of the object detection result of the object detection unit 31. FIG. 5 illustrates information of one voxel forming the 3D map. A voxel v includes, for example, the signed distance D(v), the weight parameter W(v), and the object ID label L(v). Furthermore, the voxel v may include an object category label indicating a category of an object.

Furthermore, when the detection target object that coincides with the registered object is detected from the input image on the basis of the object detection result, the map processing unit 32 generates an object map of the detection target object on the basis of an object map of the registered object registered in the object database and integrates the same with the 3D map. Moreover, the map processing unit 32 may discriminate a moving object or a stationary object (non-moving object) in which the voxel is included on the basis of the object detection result, and may generate the object map, register in the object database and the like on the basis of a discrimination result.

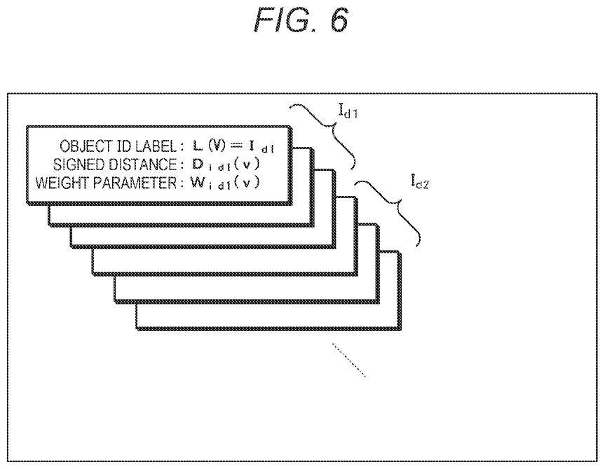

The database management unit 33 allows the storage unit 41 to store the object database. Furthermore, the database management unit 33 updates the object database on the basis of the object detection result and the like of the object detection unit 31. For example, processing of registering the object map generated by the map processing unit 32 in the object database on the basis of the moving object detection result, processing of reading and deleting the object map of the registered object from the object database on the basis of the registered object detection result and the like are executed on the object database. FIG. 6 illustrates the object database. In the object database, for example, for each object ID label being the object specific information, the signed distance and the weight parameter included in the voxel corresponding to the object are stored.

The polygon mesh extraction unit 34 extracts the polygon mesh from the 3D map generated or updated by the map processing unit 32. The polygon mesh extraction unit 34 extracts the voxels v having the signed distance D(v) of “0” for each object ID label L(v), and extracts the polygon mesh for each object ID label L(v) on the basis of the extracted voxels v.

Note that, a functional configuration of the information processing unit 30 is not limited to the configuration illustrated in FIG. 2, and for example, a function of the database management unit 33 may be divided into the object detection unit 31 and the map processing unit 32.

Returning to FIG. 1, the storage unit 41 stores the object database. Note that, the object database may be generated by the information processing unit 30 and stored in the storage unit 41, or may be generated in advance and stored in the storage unit 41. The display unit 42 adheres and the like texture corresponding to the object ID label L(v) to the polygon mesh extracted by the information processing unit 30, and generates and displays a three-dimensional image.

<2. Operation of First Embodiment of Information Processing Unit>

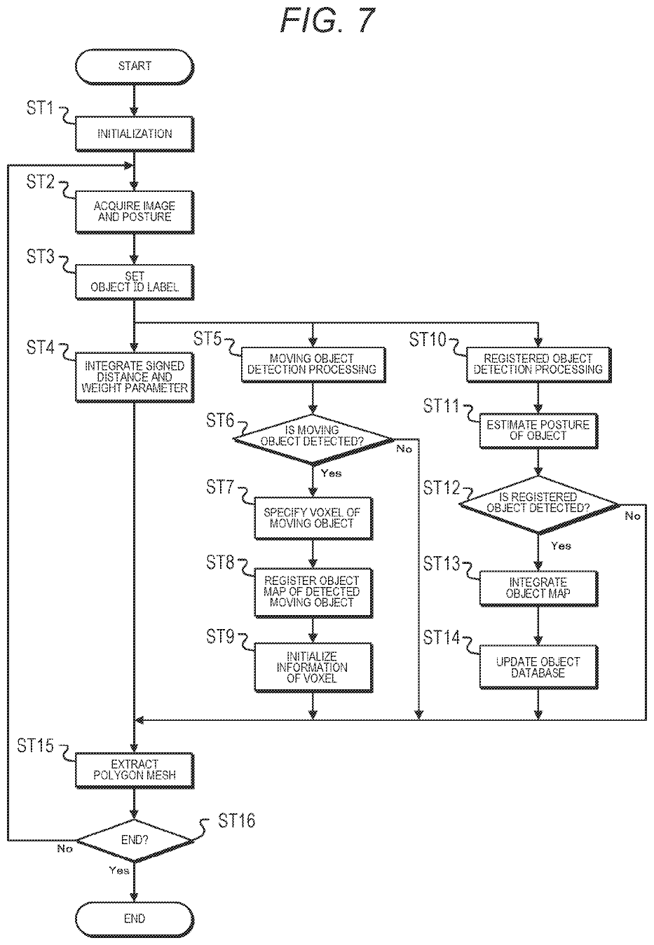

Next, an operation of the first embodiment of the information processing unit is described. FIG. 7 illustrates using a flowchart illustrating the operation of the first embodiment.

At step ST1, the information processing unit performs initialization. In the initialization, the information processing unit 30 generates the 3D map in which the signed distance D(v), the weight parameter W(v), and the object ID label L(v) are not defined. Furthermore, the information processing unit 30 provides the object database indicating the object ID label L(v), the signed distance D(v), and the weight parameter W(v) of the voxel indicating the moving object, and shifts to step ST2.

At step ST2, the information processing unit acquires the image and the posture. The information processing unit 30 acquires the depth image and the captured image from the sensor unit 21. Furthermore, the information processing unit 30 acquires the posture information from the posture detection unit 22 and shifts to step ST3.

At step ST3, the information processing unit sets the object ID label. The information processing unit 30 performs subject recognition, semantic segmentation or the like, discriminates an object formed by each voxel, sets an object ID label Ln indicating, for example, an object OBn to a voxel vn forming the object OBn, and shifts to steps ST4, 5, and 10.

At step ST4, the information processing unit integrates the signed distance and the weight parameter. The information processing unit 30 calculates the signed distance D(v) and the weight parameter W(v) for each voxel v using, for example, a method disclosed in Non-Patent Document 2 “Narita, Gaku, et al. “PanopticFusion: Online Volumetric Semantic Mapping at the Level of Stuff and Things.” arXiv preprint arXiv:1903.01177 (2019)” or Non-Patent Document 3 “Grinvald, Margarita, et al. “Volumetric Instance-Aware Semantic Mapping and 3D Object Discovery.” arXiv preprint arXiv:1903.00268 (2019)”. Moreover, the information processing unit 30 includes the signed distance D(v), the weight parameter W(v), and the object ID label L(v) in the voxel v of the 3D map and shifts to step ST15.

At step ST5, the information processing unit performs moving object detection processing. The information processing unit detects the moving object from the image acquired at step ST2.

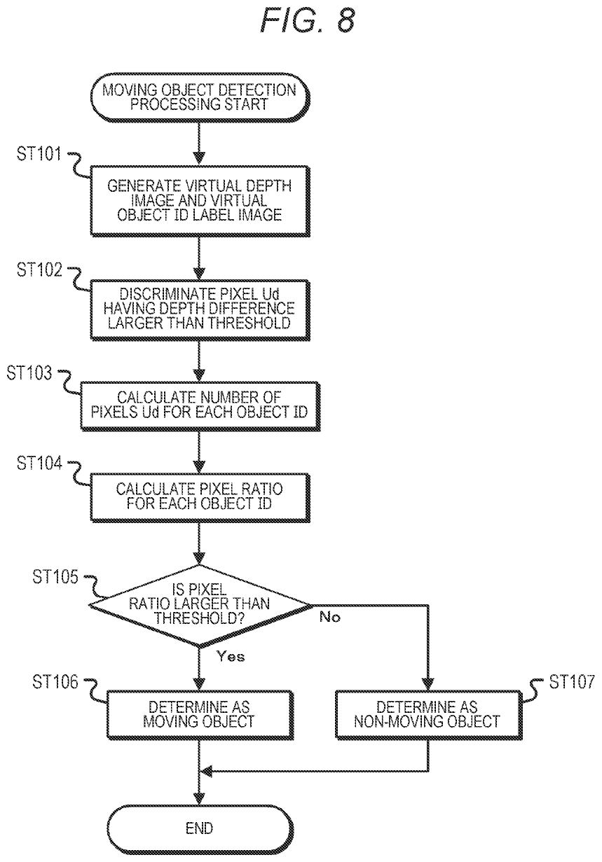

FIG. 8 is a flowchart illustrating the moving object detection processing. At step ST101, the information processing unit generates a virtual depth image and a virtual object ID label image. Regarding each pixel u of a depth image G(u) acquired at step ST2, the information processing unit 30 performs ray-casting on the 3D map from the sensor center, and determines zero crossing of the signed distance D(v) stored in each voxel of the 3D map. Moreover, the information processing unit 30 generates a virtual depth image PG(u) indicating a distance to the voxel indicating the zero crossing on the basis of a determination result of the zero crossing. Furthermore, the information processing unit 30 generates a virtual object ID label image PB(u) by using the object ID label of the voxel of the zero crossing, and shifts to step ST102.

At step ST102, the information processing unit discriminates a pixel Ud having a depth difference larger than a threshold. The information processing unit 30 discriminates a pixel in which the depth difference between a depth value E(u) of the depth image G(u) and a depth value PE(u) of the virtual depth image PG(u) is larger than a threshold set in advance. For example, the information processing unit defines a pixel having the depth difference larger than a threshold value Eth as the pixel Ud on the basis of Expression (3), and shifts to step ST103.

$$\begin{matrix}[ Math . 2 ] & \\ {U}_{d} := \{ u \vert \frac{E ( u ) - PE ( u )}{PE ( u )} > {E}_{th} \} & ( 3 )\end{matrix}$$

At step ST103, the information processing unit calculates the number of pixels Ud for each object ID. The information processing unit 30 calculates the number of pixels Ud for each object ID indicated by the virtual object ID label image PB(u), that is, for each object, and shifts to step ST104.

At step ST104, the information processing unit calculates a pixel ratio for each object ID. The information processing unit 30 sets a pixel ratio RUd indicating a rate of the pixels Ud for each object ID, that is, for each object, for the object with the object ID label L in the virtual object ID label image PB(u) on the basis of, for example, Expression (4), and shifts to step ST105.

$$\begin{matrix}[ Math . 3 ] & \\ {RU}_{d} := \frac{\{ u \vert u ∈ {U}_{d} ⋂ PB ( u ) = L \}}{\{ u \vert PB ( u ) = L \}} & ( 4 )\end{matrix}$$

At step ST105, the information processing unit determines whether or not the pixel ratio is larger than a threshold. The information processing unit 30 shifts to step ST106 when the pixel ratio RUd is larger than a threshold RUth, and shifts to step ST107 when the pixel ratio RUd is equal to or smaller than the threshold RUth.

At step ST106, the information processing unit determines that it is the moving object. The information processing unit 30 discriminates the object to which the object ID label having the pixel ratio RUd larger than the threshold RUth is assigned as the moving object. Note that, a set of the object ID labels of the objects discriminated as the moving objects is set as SLd.

At step ST107, the information processing unit determines that it is the non-moving object. The object to which the object ID label having the pixel ratio RUd equal to or smaller than the threshold RUth is assigned is discriminated as the non-moving object.

Note that, the detection of the moving object is not limited to a case of using the depth difference as illustrated in FIG. 8. For example, a pixel value difference between the captured image acquired by the imaging unit 211 and a virtual captured image acquired by ray-casting may also be used, or the moving object may be discriminated on the basis of an optical flow, a scene flow and the like calculated from the captured images of a plurality of frames acquired by the imaging unit 211.

Returning to FIG. 7, the information processing unit determines whether or not the moving object is detected at step ST6. The information processing unit 30 shifts to step ST7 when the moving object is detected at step ST5, and shifts to step ST15 when the moving object is not detected.

At step ST7, the information processing unit specifies the voxel of the moving object. A voxel v(Ld) including an object ID label Ld of the object determined to be the moving object is set as the voxel of the moving object, and the procedure shifts to step ST8. Note that, the object ID label Ld is the label included in the set of the object ID labels of the moving objects SLd as expressed by Expression (5), and the voxel v(Ld) is the voxel expressed by Expression (6).

[Math. 4]

L_{d} ∈ SL_{d} (5)

V(L_{d}):={v|L(v)=L_{d}} (6)

The information processing unit registers the object map of the detected moving object at step ST8. The information processing unit registers the object map being the 3D map including information of the voxel v(Ld) indicating the object ID label Ld of the moving object in the object database so that the moving object may be detected in redetection processing to be described later, and shifts to step ST9. Therefore, the 3D map indicating a signed distance DLd(v), a weight parameter WLd(v), and an object ID label Ld is registered in the object database for each detected moving object. Note that, the information registered in the object database may include the object category label of the moving object.

At step ST9, the information processing unit initializes the information of the voxel of the moving object. The information processing unit performs, for example, processing of Expression (7) on the voxel of the moving object in the 3D map, and sets the signed distance D(v) to “0” for each voxel v of the voxels v(Ld) of the object ID label Ld. Furthermore, the weight parameter W(v) and the object ID label L(v) are also initialized on the basis of Expressions (8) and (9), and the procedure shifts to step ST15. Note that, in Expression (9), “l_{unknown}” indicates that the object ID label is not defined.

[Math. 5]

∀v ∈ V(L_{d}), D(v)←0 (7)

∀v ∈ V(L_{d}), W(v)←0 (8)

∀v ∈ V(L_{d}), L(v)←L_{unknown} (9)

The initialization of the voxel corresponds to erasing the information of a past scan point group stored in the voxel, and only information acquired from a next scan point group is reflected on an initialized voxel. Therefore, in the initialized voxel, a zero crossing surface present in the vicinity of the surface of the moving object disappears, and the polygon mesh of the moving object is immediately deleted in polygon mesh extraction processing to be described later.

At step ST10, the information processing unit performs registered object detection processing. The information processing unit 30 detects the object registered in the object database of the storage unit 41.

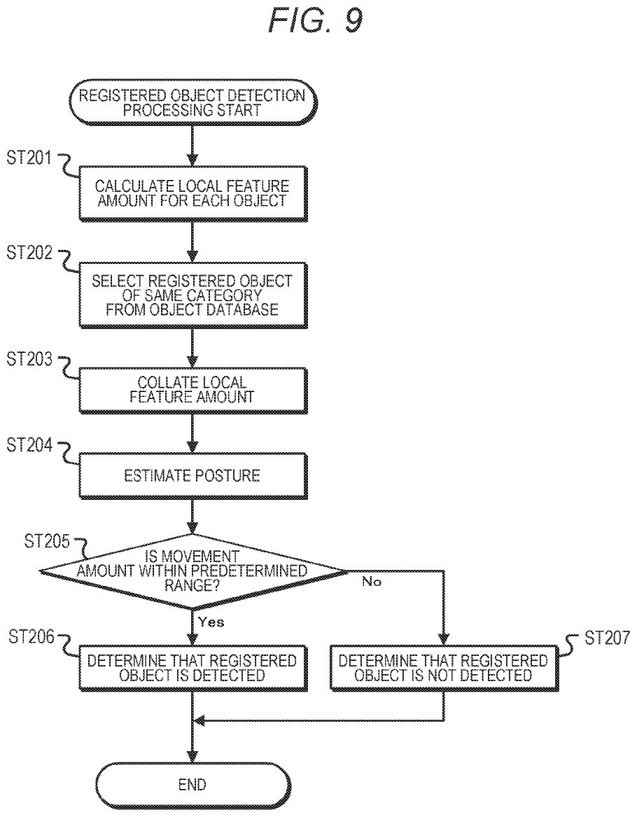

FIG. 9 is a flowchart illustrating the registered object detection processing. At step ST201, the information processing unit calculates a local feature amount for each object. On the basis of the object ID label image indicating the object ID label set at step ST3 in FIG. 7, the information processing unit 30 distinguishes each object (referred to as a “detection target object”) in the input image and detects a feature point for each detection target object. Moreover, the information processing unit 30 calculates the local feature amount of the detected feature point and shifts to step ST202. For the detection of the feature point and the calculation of the local feature amount, for example, an image-based technique such as scale invariant feature transform (SIFT) or speeded up robust features (SURF) may be used, a point group-based technique such as signature of histograms of orientations (SHOT) or fast point feature histogram (FPFH) may be used, or both of them may be used.

At step ST202, the information processing unit detects the registered object of the same category from the object database. When the object category is used in the 3D map and the object database of the storage unit 41, the information processing unit 30 detects the registered object of the same category as that of the detection target object in the image from the object database, and shifts to step ST203.

At step ST203, the information processing unit collates the local feature amount. The local feature amount calculated at step ST201 is collated with the local feature amount of the registered object registered in the object database, a corresponding point of the registered object corresponding to the feature point of the detection target object is estimated, and the procedure shifts to step ST204.

At step ST204, the information processing unit performs posture estimation. The information processing unit 30 estimates a movement amount from registration time of the registered object in the object database to acquisition time at which the input image used for detecting the detection target object is acquired, for example, for the feature point of the detection target object and the corresponding point of the registered object on the basis of the posture information acquired by the posture detection unit 22, and shifts to step ST205.

Note that, in the estimation of the corresponding point at step ST203 and the posture estimation at step ST204, when an algorithm of robust estimation, for example, random sample consensus (RANSAC), least median of squares (LMedS) and the like is used, the estimation may be performed with high accuracy.

At step ST205, the information processing unit determines whether or not the movement amount is in a predetermined range. For example, a movable speed is set in advance according to the registered object, and a predetermined range in which the registered object is movable is set on the basis of an elapsed time from the registration time to the acquisition time and the movable speed. The information processing unit 30 shifts to step ST206 when the movement amount estimated at step ST204 is within the predetermined range, and shifts to step ST207 when this exceeds the predetermined range. Note that, the predetermined range may be a range in which either a minimum value or a maximum value is set, or may be a range in which the minimum value and the maximum value are set.

At step ST206, the information processing unit determines that the registered object is detected. The information processing unit 30 determines that the registered object corresponding to the detection target object is detected.

At step ST207, the information processing unit determines that the registered object is not detected. The information processing unit 30 determines that the registered object corresponding to the detection target object is not detected. For example, when the registered object is heavy, so that the predetermined range is narrow, if the detection target object is similar to the registered object and is a lightweight object different from the registered object, the movement amount becomes large and exceeds the predetermined range. In such a case, even if the detection target object is similar to the registered object, this is discriminated to be different from the registered object, and the registered object is not detected.

Returning to FIG. 7, the information processing unit estimates a posture of the object at step ST11. The information processing unit 30 estimates the posture of the detection target object corresponding to the registered object using the registered object detected in the registered object detection processing at step ST10 as a reference, and shifts to step ST12.

At step ST12, the information processing unit determines whether or not the registered object registered in the database is detected. In the registered object detection processing at step ST10, the information processing unit 30 shifts to step ST13 when it is determined that the registered object is detected, and shifts to step ST15 when it is determined that the registered object is not detected.

At step ST13, the information processing unit integrates the object map. The information processing unit 30 integrates the object map of the registered object corresponding to the detection target object stored in the object database with the 3D map using a posture TLd estimated at step ST11. In the integration, a position in the 3D map in which each voxel of the object map of the registered object detected at step ST10 is located is discriminated, and the information of the voxel of the 3D map is replaced with information calculated using the information of the voxel of the object map located in the vicinity. The information processing unit 30 defines the signed distance D(v) of the three-dimensional map on the basis of the posture TLd and the signed distance DLd of the object map, for example, as expressed by Expression (10). Similarly, the information processing unit 30 defines the weight parameter W(v) and the object ID label Ld of the three-dimensional map on the basis of the posture TLd, the weight parameter WLd of the object map, and the object ID=Id, for example, as expressed by Expressions (11) and (12).

[Math. 6]

∀v s. t. D_{L}_{_{d}}(T_{L}_{_{d}}⁻¹v) is defined, D(v)←TrilinearInterp(D_{L}_{_{d}}(T_{L}_{_{d}}⁻¹v)) (10)

∀v s. t. D_{L}_{_{d}}(T_{L}_{_{d}}⁻¹v) is defined, W(v)←TrilinearInterp(W_{L}_{_{d}}(T_{L}_{_{d}}⁻¹v)) (11)

∀v s. t. D_{L}_{_{d}}(T_{L}_{_{d}}⁻¹v) is defined, L(v)←L_{d} (12)

In Expressions (10) and (11), “TrilinearInterp” represents trilinear interpolation using eight voxels in the vicinity; interpolation is performed using the eight voxels in the vicinity in the object map to calculate the signed distance and the weight parameter of the voxel in the 3D map. Note that, the interpolation may be performed using a method other than the trilinear interpolation such as nearest neighbor interpolation or tricubic interpolation. The information processing unit 30 performs such integration processing, integrates the object map of the registered object corresponding to the detection target object with the 3D map corresponding to the posture of the detection target object, and shifts to step ST14. Therefore, when the polygon mesh extraction processing to be described later is performed using the 3D map with which the object map is integrated, the polygon mesh of the detection target object for which the registered object is detected is immediately extracted.

At step ST14, the information processing unit updates the object database. The information processing unit 30 deletes the object map of the registered object corresponding to the detection target object detected from the input image from the database, and shifts to step ST15.

At step ST15, the information processing unit extracts the polygon mesh. The information processing unit 30 extracts the polygon mesh from the 3D map on the basis of the voxels having the signed distance of zero indicating the object surface and indicating the same object ID label, using, for example, Marching Cube algorithm disclosed in Non-Patent Document 4 “Lorensen, William E., and Harvey E. Cline. “Marching cubes: A high resolution 3D surface construction algorithm.” ACM siggraph computer graphics. Vol. 21, No. 4. ACM, 1987.” and the like, and shifts to step ST16.

At step ST16, the information processing unit determines whether or not the extraction of the polygon mesh based on the 3D map ends. When the extraction of the polygon mesh of the object is continued on the basis of the 3D map, the information processing unit returns to step ST2, acquires new image and posture, and extracts the polygon mesh. Furthermore, when the extraction of the polygon mesh of the object is not continued, the procedure ends.

In this manner, according to the present technology, when the moving object is detected, the information of the 3D map indicating the moving object is deleted, so that it is possible to quickly prevent the polygon mesh of the moving object from being extracted. Furthermore, when the moving object is detected, the object map of the moving object is registered in the object database. Furthermore, when the object the same as the registered object registered in the object database is detected from the input image, the object map of the registered object corresponding to the detected object is integrated with the 3D map, so that the polygon mesh of the object may be quickly extracted.

That is, when the object present in an environment moves and the position and the posture thereof change, the change in the position of the object is quickly reflected on the 3D map, so that it is possible to prevent latency of a certain period of time or more from occurring until the polygon mesh of the moving object is deleted, and latency of a certain period of time or more from occurring until the polygon mesh of the moving object is extracted.

For example, when the signed distance and the like is updated as in the conventional technology, since it takes time until the change in the environment is reflected on the 3D map, interaction with the object that has already moved is continued, or it takes time until an appeared obstacle is reflected on the 3D map, so that a problem such as collision with the obstacle occurs. However, according to the present technology, since the change in the environment is quickly reflected on the 3D map, it is possible to prevent the problem in a case of using the conventional technology.

<3. Operation of Another Embodiment of Information Processing Unit>

Next, an operation of another embodiment is described. In the first embodiment, a method of updating a 3D map using a signed distance field is described, but an object registered in an object database may include not only an object determined to be a moving object but also a non-moving object.

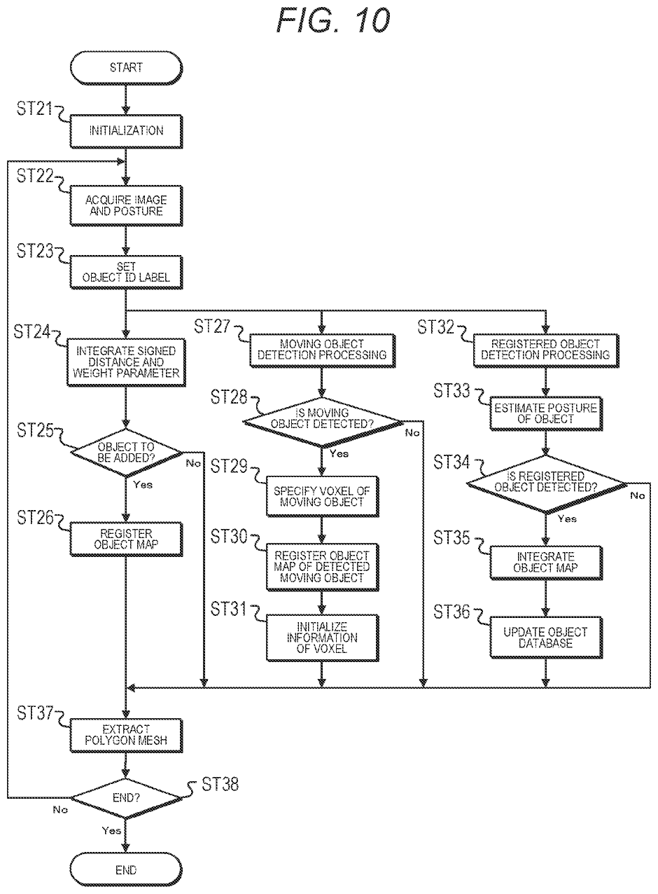

FIG. 10 is a flowchart illustrating an operation of another embodiment, and a case where a moving object or a non-moving object is registered in an object database is described.

At step ST21, an information processing unit performs initialization. An information processing unit 30 generates a 3D map in which a signed distance D(v), a weight parameter W(v), and an object ID label L(v) are not defined as at step ST1 in FIG. 7. Furthermore, the information processing unit 30 provides an object database indicating the object ID label L(v), the signed distance D(v), and the weight parameter W(v) of a voxel indicating an object, and shifts to step ST22.

At step ST22, the information processing unit acquires an image and a posture. The information processing unit 30 acquires a depth image and a captured image from a sensor unit 21. Furthermore, the information processing unit 30 acquires posture information from a posture detection unit 22 and shifts to step ST23.

At step ST23, the information processing unit sets the object ID label. As at step ST3 in FIG. 7, the information processing unit 30 discriminates an object formed by each voxel, sets the object ID label to the voxel on the basis of a discrimination result, and shifts to steps ST24, 27, and 32.

At step ST24, the information processing unit integrates the signed distance and the weight parameter. The information processing unit 30 calculates the signed distance D(v) and the weight parameter W(v) as at step ST4 in FIG. 7. Moreover, the information processing unit 30 includes the signed distance D(v), the weight parameter W(v), and the object ID label L(v) in a voxel v of the 3D map and shifts to step ST25.

At step ST25, the information processing unit determines whether or not it is an object to be added. The information processing unit 30 shifts to step ST26 when an input image includes, for example, a moving object or a non-moving object to be added, an object map of which is to be registered in the object database, and shifts to step ST37 when the input image does not include them.

At step ST26, the information processing unit registers the object map. The information processing unit 30 registers the object map indicating the object to be added in the object database, and shifts to step ST37.

At step ST27, the information processing unit performs moving object detection processing. The information processing unit detects the moving object as at step ST5 in FIG. 7 from the image acquired at step ST22, and shifts to step ST28.

The information processing unit determines whether or not the moving object is detected at step ST28. The information processing unit 30 shifts to step ST29 when the moving object is detected at step ST27, and shifts to step ST37 when the moving object is not detected.

At step ST29, the information processing unit specifies the voxel of the moving object. As at step ST7 in FIG. 7, the information processing unit 30 sets a voxel v(Ld) including an object ID label Ld of the object determined to be the moving object as the voxel of the moving object, and shifts to step ST30.

The information processing unit registers the object map of the detected moving object at step ST30. The information processing unit registers the object map indicating the detected moving object in the object database as at step ST8 in FIG. 7, and shifts to step ST31.

At step ST31, the information processing unit initializes information of the voxel. As at step ST9 in FIG. 7, the information processing unit 30 initializes the information of the voxel of the moving object in the 3D map, and shifts to step ST37.

At step ST32, the information processing unit performs registered object detection processing. The information processing unit 30 detects a detection target object registered in the object database of a storage unit 41 as at step ST10 in FIG. 7, and shifts to step ST33.

At step ST33, the information processing unit estimates a posture of the object. As at step ST11 in FIG. 7, the information processing unit 30 estimates the posture of the detection target object corresponding to a registered object using the registered object detected in the registered object detection processing at step ST32 as a reference, and shifts to step ST34.

At step ST34, the information processing unit determines whether or not the registered object registered in the database is detected. In the registered object detection processing at step ST32, the information processing unit 30 shifts to step ST35 when it is determined that the registered object is detected, and shifts to step ST37 when it is determined that the registered object is not detected.

At step ST35, the information processing unit integrates the object map. As at step ST13 in FIG. 7, the information processing unit 30 integrates the object map corresponding to the detection target object stored in the object database with the 3D map using the posture estimated at step ST33 and shifts to step ST36.

At step ST36, the information processing unit updates the object database. The information processing unit 30 deletes the object map of the registered object corresponding to the detection target object detected from the input image from the database, and shifts to step ST37.

At step ST37, the information processing unit extracts a polygon mesh. The information processing unit 30 detects the voxels the signed distance of which is zero indicating an object surface from the 3D map, extracts the polygon mesh from the detected voxels on the basis of the voxels having the same object ID label, and shifts to step ST38.

At step ST38, the information processing unit determines whether or not the extraction of the polygon mesh based on the 3D map ends. When the extraction of the polygon mesh of the object is continued on the basis of the 3D map, the information processing unit returns to step ST22, acquires new image and posture, and extracts the polygon mesh. Furthermore, when the extraction of the polygon mesh of the object is not continued, the procedure ends.

By performing such processing, processing similar to that of the moving object becomes possible not only when an object in an environment moves, for example, the moving object is detected, but also when an information processing device of the present technology is provided on a mobile object and the non-moving object moves, and the moved non-moving object may be immediately deleted from the polygon mesh extracted from the 3D map. Furthermore, it is possible to quickly extract the polygon mesh regarding the non-moving object when not only the moving object but also the non-moving object moves to be detected.

Moreover, the object database may be created in advance. As a method of creating the object database in advance, for example, individual objects present in the environment may be created on the basis of 3D scanning using the methods disclosed in Non-Patent Document 2 and Non-Patent Document 3 mentioned above, or may be created from a three-dimensional CAD model having the same or similar shape as that of the individual objects present in the environment.

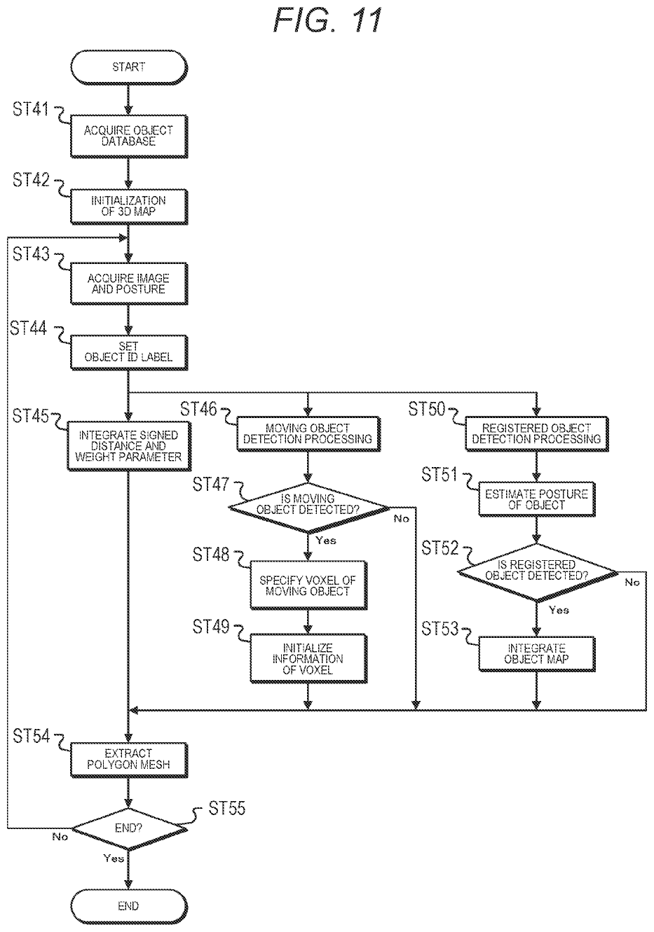

FIG. 11 is a flowchart illustrating an operation of another embodiment, in which a case where the object database is created in advance is illustrated.

At step ST41, the information processing unit acquires the object database. The information processing unit acquires the object database generated using the above-described method, and shifts to step ST42.

At step ST42, the information processing unit performs initialization of the 3D map. The information processing unit 30 prepares the 3D map in which the signed distance D(v), the weight parameter W(v), and the object ID label L(v) are not defined and shifts to step ST43.

At step ST43, the information processing unit acquires the image and the posture. The information processing unit 30 acquires the depth image and the captured image from the sensor unit 21. Furthermore, the information processing unit 30 acquires the posture information from the posture detection unit 22 and shifts to step ST44.

At step ST44, the information processing unit sets the object ID label. As at step ST3 in FIG. 7, the information processing unit 30 discriminates an object formed by each voxel, sets the object ID label L(v) to the voxel v on the basis of a discrimination result, and shifts to steps ST45, 46, and 50.

At step ST45, the information processing unit integrates the signed distance and the weight parameter. The information processing unit 30 calculates the signed distance D(v) and the weight parameter W(v) as at step ST4 in FIG. 7. Moreover, the information processing unit 30 includes the signed distance D(v), the weight parameter W(v), and the object ID label L(v) in the voxel v of the 3D map and shifts to step ST54.

At step ST46, the information processing unit performs moving object detection processing. The information processing unit performs the moving object detection processing as at step ST5 in FIG. 7 from the image acquired at step ST43, and shifts to step ST47.

The information processing unit determines whether or not the moving object is detected at step ST47. The information processing unit 30 shifts to step ST48 when the moving object is detected at step ST46, and shifts to step ST54 when the moving object is not detected.

At step ST48, the information processing unit specifies the voxel of the moving object. As at step ST7 in FIG. 7, the information processing unit 30 sets the voxel v(Ld) including the object ID label Ld of the object determined to be the moving object as the voxel of the moving object, and shifts to step ST49.

At step ST49, the information processing unit initializes the information of the voxel. As at step ST9 in FIG. 7, the information processing unit 30 initializes the information of the voxel of the moving object in the 3D map, and shifts to step ST54.

At step ST50, the information processing unit performs the registered object detection processing. The information processing unit 30 detects the detection target object registered in the object database of the storage unit 41 as at step ST10 in FIG. 7, and shifts to step ST51.

At step ST51, the information processing unit estimates the posture of the object. As at step ST11 in FIG. 7, the information processing unit 30 estimates the posture of the detection target object corresponding to the registered object using the registered object detected in the registered object detection processing at step ST50 as the reference, and shifts to step ST52.

At step ST52, the information processing unit determines whether or not the registered object registered in the database is detected. In the registered object detection processing at step ST50, the information processing unit 30 shifts to step ST53 when it is determined that the registered object is detected, and shifts to step ST54 when it is determined that the registered object is not detected.

At step ST53, the information processing unit integrates the object map. As at step ST13 in FIG. 7, the information processing unit 30 integrates the object map corresponding to the detection target object stored in the object database with the 3D map using the posture estimated at step ST51 and shifts to step ST54.

At step ST54, the information processing unit extracts the polygon mesh. The information processing unit 30 detects the voxels the signed distance of which is zero indicating the object surface from the 3D map, extracts the polygon mesh from the detected voxels on the basis of the voxels having the same object ID label, and shifts to step ST55.

At step ST55, the information processing unit determines whether or not the extraction of the polygon mesh based on the 3D map ends. When the extraction of the polygon mesh of the object is continued on the basis of the 3D map, the information processing unit returns to step ST43, acquires the new image and posture, and extracts the polygon mesh. Furthermore, when the extraction of the polygon mesh of the object is not continued, the procedure ends.

By performing such processing, when the object in the environment moves, the moved object may be immediately deleted from the polygon mesh. Furthermore, when the object registered in the object database is detected, it is possible to quickly extract the polygon mesh regarding the object even when the object is the non-moving object in addition to the moving object. Therefore, when the information processing device is provided on the mobile object and the non-moving object around the same is included in a sensing range of the sensor unit 21, the polygon mesh of the non-moving object may be quickly extracted.

Moreover, in the above-described embodiment, a case of using the 3D map including the signed distance is described, but the present invention is similarly applicable to a 2D map in which a space is viewed from above in a vertical direction.

<4. Application Example>

The technology according to the present disclosure may be applied to various fields. For example, in augmented reality (AR), virtual reality (VR), robotics and the like, it becomes possible to extract a polygon mesh with low latency when a dynamic environment around a user or a robot is three-dimensionally reconstructed. Therefore, it becomes possible to accurately perform detection of a free space in which an important object is not present in an action plan, drawing of occlusion, physical simulation and the like.

A series of processing described in the specification may be executed by hardware, software, or a composite configuration of both. When the processing by the software is executed, a program in which a processing sequence is recorded is installed in a memory in a computer incorporated in dedicated hardware and executed. Alternatively, it is possible to install and execute the program in a general-purpose computer capable of executing various pieces of processing.

For example, the program may be recorded in advance in a hard disk, a solid state drive (SSD), and a read only memory (ROM) as a recording medium. Alternatively, the program may be temporarily or permanently stored (recorded) in a removable recording medium such as a flexible disk, a compact disc read only memory (CD-ROM), a magneto optical (MO) disk, a digital versatile disc (DVD), a Blu-ray Disc (BD) (registered trademark), a magnetic disk, and a semiconductor memory. Such removable recording medium may be provided as so-called package software.

Furthermore, in addition to be installed from the removable recording medium into the computer, the program may be transferred wirelessly or by wire from a download site to a computer via a network such as a local area network (LAN) or the Internet. In the computer, it is possible to receive the program transferred in this manner and to install the same on a recording medium such as a built-in hard disk.

Note that, the effect described in this specification is illustrative only and is not limited; there may be an additional effect not described. Furthermore, the present technology should not be construed as being limited to the above-described embodiment of the technology. The embodiment of this technology discloses the present technology in the form of illustration, and it is obvious that those skilled in the art may modify or replace the embodiment without departing from the gist of the present technology. That is, in order to determine the gist of the present technology, claims should be taken into consideration.

Furthermore, the information processing device of the present technology may also have the following configuration.

(1) An information processing device including:

an object detection unit that detects an object from an input image; and

a map processing unit that updates information of an area corresponding to the detected object in an environment map according to a detection result of the object by the object detection unit.

(2) The information processing device according to (1), in which the map processing unit initializes, when the object detection unit detects a moving object, information of an area corresponding to the moving object in the environment map.

(3) The information processing device according to (2), in which the map processing unit registers an object map of the moving object detected by the object detection unit in an object database.

(4) The information processing device according to (2) or (3), in which the map processing unit registers an object map of a non-moving object detected by the object detection unit in the object database.

(5) The information processing device according to any one of (1) to (4), in which

the object detection unit detects, from the input image, a detection target object that coincides with a registered object registered in an object database, and

the map processing unit integrates, when the object detection unit detects the detection target object, an object map of the registered object that coincides with the detection target object with the environment map.

(6) The information processing device according to (5), in which the map processing unit converts the object map of the registered object that coincides with the detection target object into a map according to a posture of the detection target object, and integrates the converted object map with the environment map.

(7) The information processing device according to (6), in which the map processing unit deletes the registered object that coincides with the detection target object from the object database.

(8) The information processing device according to any one of (1) to (7), in which the environment map is a three-dimensional map including a signed distance, a weight parameter, and object specific information.

(9) The information processing device according to (8), further including: a polygon mesh extraction unit that extracts a polygon mesh from the three-dimensional map updated by the map processing unit.

(10) The information processing device according to (9), in which the polygon mesh extraction unit extracts the polygon mesh for each object on the basis of the object specific information.

### REFERENCE SIGNS LIST

10 System
21 Sensor unit
22 Posture detection unit
30 Information processing unit
31 Object detection unit
32 Map processing unit
33 Database management unit
34 Polygon mesh extraction unit
41 Storage unit
42 Display unit
211 Imaging unit
212 Ranging unit

1. An information processing device comprising:
an object detection unit that detects an object from an input image; and
a map processing unit that updates information of an area corresponding to the detected object in an environment map according to a detection result of the object by the object detection unit.

2. The information processing device according to claim 1, wherein
the map processing unit initializes, when the object detection unit detects a moving object, information of an area corresponding to the moving object in the environment map.

3. The information processing device according to claim 2, wherein
the map processing unit registers an object map of the moving object detected by the object detection unit in an object database.

4. The information processing device according to claim 3, wherein
the map processing unit registers an object map of a non-moving object detected by the object detection unit in the object database.

5. The information processing device according to claim 1, wherein
the object detection unit detects, from the input image, a detection target object that coincides with a registered object registered in an object database, and
the map processing unit integrates, when the object detection unit detects the detection target object, an object map of the registered object that coincides with the detection target object with the environment map.

6. The information processing device according to claim 5, wherein
the map processing unit converts the object map of the registered object that coincides with the detection target object into a map according to a posture of the detection target object, and integrates the converted object map with the environment map.

7. The information processing device according to claim 6, wherein
the map processing unit deletes the registered object that coincides with the detection target object from the object database.

8. The information processing device according to claim 1, wherein
the environment map is a three-dimensional map including a signed distance, a weight parameter, and object specific information.

9. The information processing device according to claim 8, further comprising:
a polygon mesh extraction unit that extracts a polygon mesh from the three-dimensional map updated by the map processing unit.

10. The information processing device according to claim 9, wherein
the polygon mesh extraction unit extracts the polygon mesh for each object on a basis of the object specific information.

11. An information processing method comprising:
detecting an object from an input image by an object detection unit; and
updating information of an area corresponding to the detected object in an environment map by a map processing unit according to a detection result of the object by the object detection unit.

12. A program for causing a computer to execute processing of an environment map, the program for causing the computer to execute:
a procedure of detecting an object from an input image; and
a procedure of updating information of an area corresponding to the detected object in the environment map according to a detection result of the object by the object detection unit.
